(19) United States
(12) Patent Application Publication
(10) Pub. No.: US 2026/0068003 A1
(43) Pub. Date: Mar. 5, 2026

(54) METHOD OF CONTROLLING HEATER AND AEROSOL-GENERATING DEVICE PERFORMING THE METHOD

(71) Applicant: KT&G CORPORATION, Daejeon (KR)

(72) Inventors: Jae Min LEE, Siheung-si (KR); Sang Kyu PARK, Seoul (KR)

(73) Assignee: KT&G CORPORATION, Daejeon (KR)

(21) Appl. No.: 19/248,649

(22) Filed: Jun. 25, 2025

(30) Foreign Application Priority Data
Aug. 29, 2024 (KR) 10-2024-0116860
Nov. 7, 2024 (KR) 10-2024-0157147

(51) Int. Cl. H05B 6/06; A24F 40/465; A24F 40/57; G05D 23/20; H05B 6/10

(52) U.S. Cl. CPC H05B 6/06; A24F 40/465; A24F 40/57; G05D 23/2033; H05B 6/105

(57) ABSTRACT

A method of controlling a heater of an aerosol-generating device includes applying a first signal having a first frequency to a coil of the heater so that an alternating magnetic field is generated, determining a first value of an electrical characteristic of a susceptor indicated by the first signal, determining a first heating frequency based on the first value, and applying a first heating signal having the first heating frequency to the coil of the heater, so that proportional-integral-differential (PID) power control is performed based on a first power profile.

### CROSS-REFERENCE TO RELATED APPLICATION

This application claims the benefit of Korean Patent Application No. 10-2024-0116860, filed on Aug. 29, 2024, and 10-2024-0157147, filed on Nov. 7, 2024, in the Korean Intellectual Property Office, the entire disclosures of which are incorporated herein by reference for all purposes.

### BACKGROUND

### 1. Field of the Invention

One or more embodiments relate to technology for controlling an aerosol-generating device, and more specifically, to technology for controlling a heater that heats a susceptor in an aerosol-generating device.

### 2. Description of the Related Art

Recently, there has been a gradual rise in the demand for electronic cigarettes. The rising demand for electronic cigarettes has accelerated the continued development of functions related to electronic cigarettes. The electronic cigarette device-related functions may include, in particular, functions according to the types and characteristics of electronic cigarette devices.

In general, in order to heat a cigarette using an induction heating method, an electronic cigarette device may generate an alternating magnetic field using a coil to generate an eddy current in a susceptor adjacent to the cigarette. The temperature of the susceptor may rise due to the eddy current generated in the susceptor. The electronic cigarette device that heats the cigarette may perform a preheating operation to heat the susceptor to a target temperature before a user starts smoking.

### SUMMARY

Embodiments provide an aerosol-generating device that preheats a susceptor by controlling, based on a power profile, the power by which the susceptor is heated.

Embodiments provide an aerosol-generating device that determines, based on an electrical characteristic of a susceptor, a frequency of a signal that is applied to a coil of a heater to heat the susceptor.

However, the technical aspects are not limited to the aforementioned aspects, and other technical aspects may be present.

According to an aspect, there is provided a method of controlling a heater of an aerosol-generating device, the method including applying a first signal having a first frequency to a coil of the heater so that an alternating magnetic field is generated, determining a first value of an electrical characteristic of a susceptor indicated by the first signal, determining a first heating frequency based on the first value, and applying a first heating signal having the first heating frequency to the coil of the heater so that proportional-integral-differential (PID) power control is performed based on a first power profile.

According to another aspect, there is provided an aerosol-generating device including an induction coil configured to generate an alternating magnetic field and a controller configured to control the aerosol-generating device, wherein the controller is further configured to apply a first signal having a first frequency to a coil to a heater so that an alternating magnetic field is generated, determine a first value of an electrical characteristic of a susceptor indicated by the first signal, determine a first heating frequency based on the first value, and apply a first heating signal having the first heating frequency to the coil of the heater so that PID power control is performed based on a first power profile.

Additional aspects of embodiments will be set forth in part in the description which follows and, in part, will be apparent from the description, or may be learned by practice of the disclosure.

According to embodiments, an aerosol-generating device may be provided which is capable of preheating a susceptor to a target temperature by controlling, based on a power profile, the power by which the susceptor is heated in some section of a preheating section of the susceptor.

According to embodiments, an aerosol-generating device may be provided which is capable of determining, based on a magnitude of an eddy current in a susceptor generated by a signal of a particular frequency, a frequency of a signal that is applied to a coil of a heater to heat the susceptor.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram of an aerosol-generating device according to one embodiment;

FIG. 2 shows an aerosol-generating device according to one embodiment;

FIG. 3 shows an aerosol-generating device according to one embodiment;

FIG. 4 shows an aerosol-generating device according to one embodiment;

FIG. 5 is a flowchart of a method of controlling a heater, according to one embodiment;

FIG. 6 is a flowchart of a method of determining whether an operation of determining a heating frequency is to be performed, according to one embodiment;

FIG. 7 is a flowchart of a method of determining an electrical characteristic of a susceptor, according to one embodiment;

FIG. 8 is a flowchart of a method of determining a heating frequency based on a sensor temperature, according to one embodiment;

FIG. 9 is a flowchart of a method of determining a heating frequency so that an electrical characteristic of a susceptor corresponds to a reference value, according to one embodiment;

FIG. 10 shows trajectories of eddy currents in a susceptor generated by a frequency of a signal, according to one embodiment; and

FIG. 11 is a flowchart of a method of preheating a susceptor, according to one embodiment.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., an aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

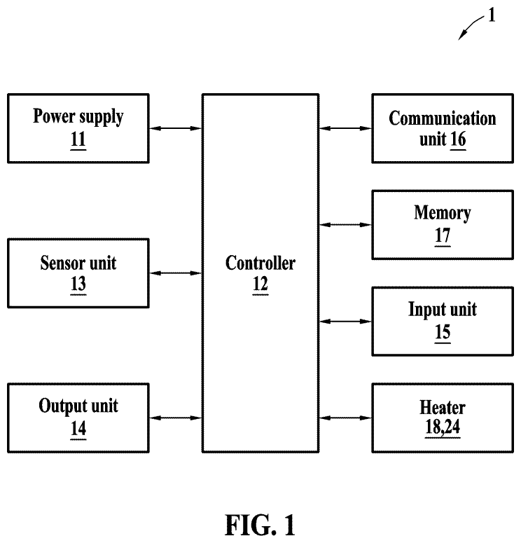

FIG. 1 is a block diagram of an aerosol-generating device according to one embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space of the aerosol-generating article, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

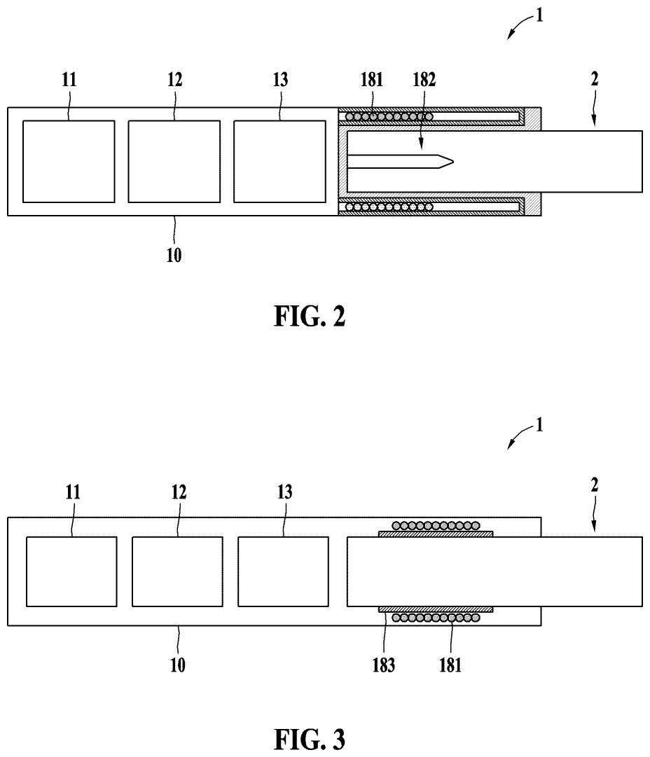

FIG. 2 shows an aerosol-generating device according to one embodiment, and FIG. 3 shows an aerosol-generating device according to one embodiment.

According to one embodiment, the aerosol-generating device 1 may include a housing 10, a power supply 11, a controller 12, a sensor unit 13, and/or a heater 182 and 183 (e.g., the heater 18 in FIG. 1). However, it will be understood by those skilled in the art related to the present embodiment that the components included in the aerosol-generating device 1 are not limited to those shown in FIG. 2 or FIG. 3 and that some of the components may be omitted or new components may be further included. The aerosol-generating device 1 shown in FIG. 2 may be referred to as an “internal heating-type” aerosol-generating device that heats the inner side of an aerosol-generating article 2. The aerosol-generating device 1 shown in FIG. 3 may be referred to as an “external heating-type” aerosol-generating device that heats the outer side of the aerosol-generating article 2. In the drawings below, a description of configurations identical to those shown in FIG. 1 will be omitted.

According to one embodiment, the housing 10 may provide a space that is open upwardly to allow the aerosol-generating article 2 to be inserted thereinto. In the present disclosure, the space that is open upwardly may be referred to as an insertion space. The insertion space may be formed so as to be depressed in the housing 10 to a predetermined depth so that at least a portion of the aerosol-generating article 2 may be inserted thereinto. The depth of the insertion space may be equal to or greater than the length of a region of the aerosol-generating article 2 in which an aerosol-generating substance and/or a medium is contained. The lower end of the aerosol-generating article 2 may be inserted into the housing 10, and the upper end of the aerosol-generating article 2 may protrude outside the housing 10. A user may inhale an aerosol while holding the externally exposed upper end of the aerosol-generating article 2 in the mouth.

According to one embodiment, the heater 182 and 183 may heat the aerosol-generating article 2.

Referring to FIG. 2, the heater 182 may be an internal heating-type heater.

According to one embodiment, the internal heating-type heater may be elongated upwardly in the space into which the aerosol-generating article 2 is inserted (i.e., the insertion space). For example, as shown in the drawings, the internal heating-type heater may include a rod-shaped or needle-shaped heating element. Alternatively, the internal heating-type heater may include various other heating elements, such as a tubular heating element or a plate-shaped heating element. The internal heating-type heater may be inserted through the lower portion of the aerosol-generating article 2.

According to one embodiment, the internal heating-type heater may include an electro-resistive heater and/or an induction heater.

For example, the electro-resistive heater may include an electro-resistive material, which is provided on the inner side (e.g., in the cavity or on the inner surface) or outer side (e.g., on the outer surface) thereof, and may generate heat as current flows through the electro-resistive material. In this case, the electro-resistive heater may be electrically connected to the power supply 11, and may directly generate heat using current received from the power supply 11. Meanwhile, an induction coil 181 may be omitted.

For example, in the case of an induction heater, the aerosol-generating device 1 may include an induction coil 181 surrounding at least a portion of the internal heating-type heater (e.g., disposed outside the heater so as to correspond to the length of at least a portion of the heater). In this case, a magnetic flux concentrator may be further provided outside the induction coil 181 in order to increase efficiency of induction heating. The induction heater may include a susceptor, and may generate heat based on a magnetic field generated by the induction coil 181. According to one embodiment, the induction heater (e.g., the susceptor) (or a heater module including the same) may be disposed to be removable from the housing 10.

According to one embodiment, the heater 182 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 182 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 182 in the longitudinal direction, respectively. In addition, three or more heaters and/or three or more induction coils may be included.

According to one embodiment, the susceptor may be disposed on (or included in) the inner side (e.g., the medium portion) of the aerosol-generating article 2. The susceptor included inside the aerosol-generating article 2 may be implemented to be heated based on a magnetic field generated by the induction coil 181.

Referring to FIG. 3, the heater 183 may be an external heating-type heater.

According to one embodiment, the external heating-type heater may be elongated upwardly around the space into which the aerosol-generating article 2 is inserted (i.e., the insertion space). For example, the external heating-type heater may be disposed so as to surround at least a portion of the insertion space. In an example, the external heating-type heater may include a tube shape (e.g., a cylindrical shape) with a cavity formed therein. The external heating-type heater may alternatively include a shape including a cavity formed therein and surrounding the cavity. In this case, the external heating-type heater may be supported by a polyimide film. The heater supported by this film may be referred to as a film heater. The external heating-type heater may be disposed so as to surround at least a portion of the insertion space. The external heating-type heater may heat the outer side of the aerosol-generating article 2 inserted into the cavity.

According to one embodiment, the external heating-type heater may include an electro-resistive heater and/or an induction heater, and a description of configurations identical to those shown in FIG. 2 will be omitted. Meanwhile, in the case of an induction heater, the aerosol-generating device 1 may include an external heating-type heater implemented as a tubular susceptor and may include an induction coil 181 surrounding at least a portion of the external heating-type heater (e.g., disposed outside the heater so as to correspond to the length of at least a portion of the heater). In addition, the induction coil 181 may include a fan coil. Meanwhile, if the external heating-type heater is an electro-resistive heater, heat may be generated through current flow through the tubular electro-resistive heater (e.g., the film heater), and thus a separate induction coil 181 may be omitted. Meanwhile, a thermally insulating material may be disposed outside the external heating-type heater. Accordingly, the amount of heat emitted from the heater 183 in the radially outward direction and released outside the housing 10 may be reduced.

According to one embodiment, the heater 183 may be a multi-heater, and the first heater and the second heater may be disposed side by side in the longitudinal direction so as to surround at least a portion of the insertion space. The first heater and the second heater may operate as an electro-resistive heater and/or an induction heater, and may be heated sequentially or simultaneously. Meanwhile, if the heater 183 is an induction heater, the aerosol-generating device 1 may include a first induction coil and a second induction coil. The first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively.

Unlike the configuration shown in FIG. 2 or FIG. 3, both the heater 182 in FIG. 2 and the heater 183 in FIG. 3 may be included in the aerosol-generating device 1. In this case, the heater 182 may heat the inner side of the aerosol-generating article 2, and the heater 183 may heat the outer side of the aerosol-generating article 2.

According to one embodiment, the aerosol-generating device 1 may be provided with an airflow channel through which air flows. For example, the housing 10 may include a structure (e.g., a hole) through which outside air may be introduced into the housing 10. The air introduced into the housing 10 may be introduced into the aerosol-generating article 2 through the lower end (i.e., upstream side) of the aerosol-generating article 2. An aerosol generated based on heating of the aerosol-generating article 2 may be inhaled into the user's oral cavity together with the introduced air through the upper end (i.e., downstream side) of the aerosol-generating article 2.

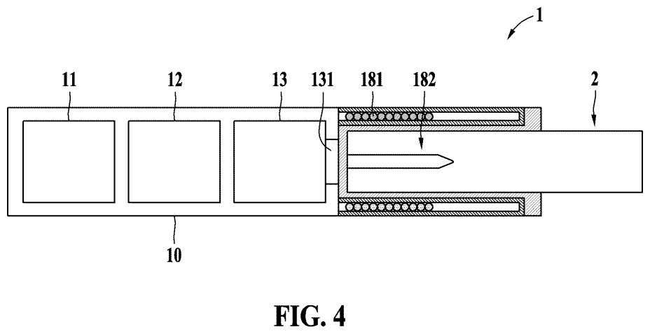

FIG. 4 shows an aerosol-generating device according to one embodiment.

According to one embodiment, the aerosol-generating device 1 may further include a temperature sensor 131. The temperature sensor 131 may be disposed within a body of the aerosol-generating device 1 to measure a temperature. For example, the temperature sensor 131 may be disposed on a lower side of a heater 182 as illustrated and may be disposed on a lower side of a rod-shaped or needle-shaped heating element included in the heater 182. For example, the controller 12 may obtain information on a rise or fall of a temperature inside the body and a temperature of the heater 182 due to an external environment or an operation of the aerosol-generating device 1 through the temperature sensor 131.

For example, the temperature sensor 131 may be a negative temperature coefficient (NTC) temperature sensor. The controller 12 may determine a temperature model of the heater 182 based on a temperature sensed by the temperature sensor 131.

According to one embodiment, the heater 182 may be an induction heater, and the heater 182 (e.g., a susceptor) (or a heater module including the same) may be disposed to be removable from the housing 10. For example, the temperature sensor 131 may be disposed to measure the temperature of the surroundings of the heater 182. Even when the heater 182 is removed from the housing 10, the temperature sensor 131 may not be removed from the housing 10.

Unlike the illustration in FIG. 4, the heater 182 may be an external heating-type heater that heats the outer side of the aerosol-generating article 2 inserted into a cavity, and the heater 182 may be disposed to be removable from the housing 10. For example, the temperature sensor 131 may be disposed to measure the temperature of the surroundings of the heater 182.

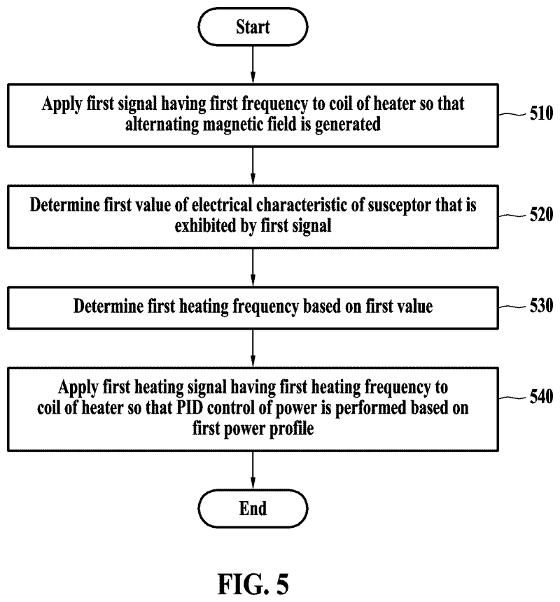

FIG. 5 is a flowchart of a method of controlling a heater, according to one embodiment.

Operations 510 to 540 below may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4).

According to one embodiment, the aerosol-generating device may control the temperature of the susceptor and/or the power by which the susceptor is heated based on a power profile (e.g., the first power profile) or a temperature profile (e.g., the first temperature profile) and may control at least one of the current, voltage, or duty ratio of a signal applied to a coil of a heater to control the temperature of the susceptor and/or the power by which the susceptor is heated. The signal applied to the coil of the heater to heat the susceptor may have a first heating frequency.

In operation 510, the aerosol-generating device may apply a first signal having a first frequency to a coil of a heater so that an alternating magnetic field may be generated. The first signal may have predetermined current, voltage, and duty ratio. For example, the first frequency may be 290 kHz.

According to one embodiment, the aerosol-generating device may perform operation 510 when an input for heating the susceptor is received. For example, since a state of the susceptor may change each time the susceptor is heated for a user's smoking, an operation of determining a frequency of a heating signal corresponding to the state of the susceptor may be newly performed.

According to one embodiment, the susceptor of the aerosol-generating device may be disposed to be removable, and the aerosol-generating device may perform operation 510 when it is determined that the disposed susceptor has been changed. For example, a changed susceptor may exhibit a different electrical characteristic from the previous susceptor, so an operation of determining the frequency of the heating signal corresponding to the change of susceptor may be newly performed.

According to one embodiment, an operation of applying the first signal to the coil may be performed for a short period of time (e.g., several milliseconds) so that the temperature of the susceptor may not increase due to an eddy current induced in the susceptor by the first signal.

According to one embodiment, the voltage of the first signal may be lower than or equal to a predetermined voltage so that the temperature of the susceptor may not increase due to the eddy current induced in the susceptor by the first signal.

According to one embodiment, the susceptor may not be electrically connected to the aerosol-generating device. Although no electricity may flow from the aerosol-generating device to the susceptor, the alternating magnetic field generated by the aerosol-generating device and the coil of the aerosol-generating device may cause an electromagnetic induction phenomenon in the susceptor to cause an eddy current to flow in the susceptor.

According to one embodiment, when an aerosol-generating article is inserted into the aerosol-generating device, the susceptor may be disposed in the aerosol-generating article. For example, the susceptor may be a tubular heating element, a plate-shaped heating element, a needle-shaped heating element, or a rod-shaped heating element.

According to one embodiment, the susceptor may be included in the aerosol-generating article inserted into the aerosol-generating device. For example, the susceptor may be included in a filter wrapping paper of the aerosol-generating article. In another example, the susceptor may be included in a tobacco rod of the aerosol-generating article.

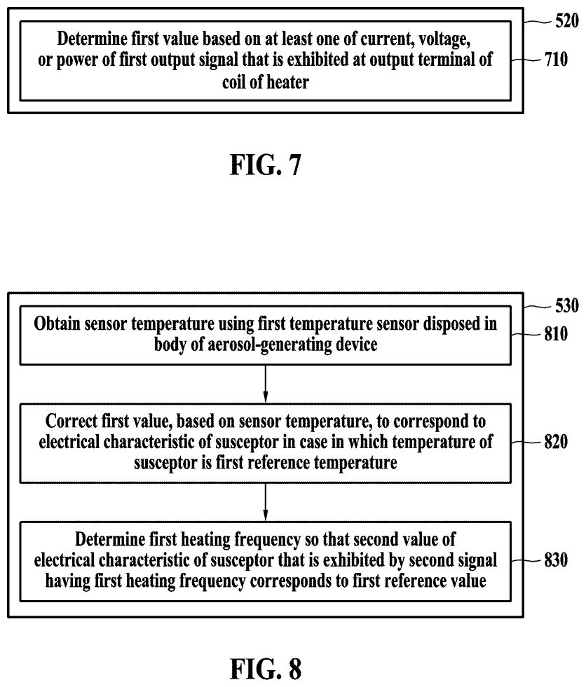

In operation 520, the aerosol-generating device may determine a first value of an electrical characteristic of the susceptor that is indicated by the first signal. An operation of determining the first value is described in detail below with reference to FIG. 7.

According to one embodiment, the aerosol-generating device may further include a detection circuit for determining the first value of the electrical characteristic of the susceptor that is indicated by the first signal at an output end of the coil of the heater. The detection circuit may not be electrically connected to the susceptor.

In operation 530, the aerosol-generating device may determine the first heating frequency based on the first value. For example, the aerosol-generating device may determine the first heating frequency so that the electrical characteristic of the susceptor that is indicated by a second signal having the first heating frequency may correspond to a first reference value. The method of determining the first heating frequency based on the first value is described in detail below with reference to FIGS. 8 to 10.

In operation 540, the aerosol-generating device may apply a first heating signal having the first heating frequency to the coil of the heater so that PID power control may be performed based on a first power profile. For example, the aerosol-generating device may preheat the susceptor by performing the PID power control until the susceptor reaches a first target temperature.

According to one embodiment, the aerosol-generating device may include a direct current (DC)/DC converter (e.g., a buck-boost converter) that receives an output voltage of a power supply (e.g., a battery) to control the voltage and applies the controlled voltage to a DC/alternating current (AC) converter (e.g., an inverter). The DC/AC converter may receive the voltage controlled by the DC/DC converter and generate a signal to be applied to the coil of the heater. A voltage of the signal and the like may be controlled based on the magnitude of the voltage that is input to the DC/AC converter.

For example, the DC/DC converter may receive a voltage of 2V to 6V and supply an input voltage ranging from a first voltage to a second voltage to the DC/AC converter. For example, when the eddy current induced in the susceptor by the signal generated by the DC/AC converter is too large or too small as the state of the susceptor changes, a voltage lower than the first voltage, which is a lower limit voltage, or a voltage higher than the second voltage, which is an upper limit voltage, may be required as the input voltage of the DC/AC converter to perform heating with a target power of the PID power control. The aerosol-generating device may determine the frequency of the heating signal so that the magnitude of an eddy current of the susceptor that is generated by the heating signal generated when the input voltage of the DC/AC converter is a predetermined reference voltage may correspond to a reference value, which may be the magnitude of an eddy current generated in a reference susceptor. Accordingly, the aerosol-generating device may stably perform the PID power control even when a voltage higher or lower than the reference voltage is required as the input voltage of the DC/AC converter.

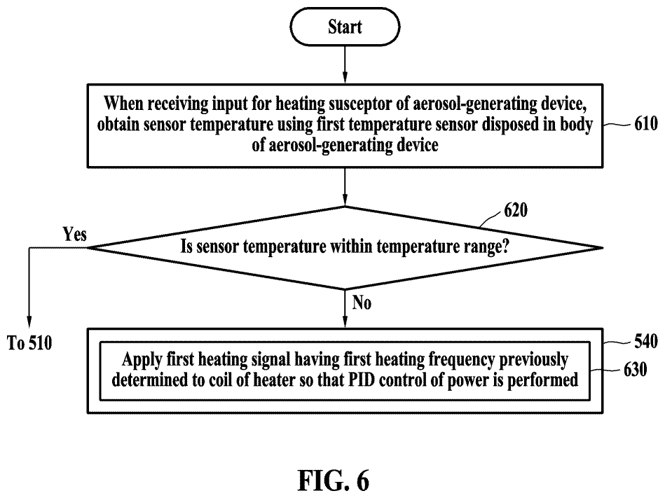

FIG. 6 is a flowchart of a method of determining whether an operation of determining a heating frequency is to be performed, according to one embodiment.

Operations 610 to 630 below may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operations 610 and 620 may be performed before operation 510 or 540 described above with reference to FIG. 5 is performed, and operation 540 may include operation 630.

According to one embodiment, the aerosol-generating device may perform operations for determining a frequency of a heating signal when an input for heating the susceptor is received. For example, when it is determined that consecutive smoking is being performed or that the frequency of the heating signal may be incorrectly determined, the aerosol-generating device may not perform operations for determining the frequency of the heating signal but may perform PID power control, using the signal having the first heating frequency that is previously determined.

According to one embodiment, the aerosol-generating device may include a first temperature sensor (e.g., the temperature sensor 131 of FIG. 4) disposed adjacent to the susceptor to measure a temperature and may determine, based on a first sensor temperature sensed by the first temperature sensor, whether to perform operations of determining the heating frequency. For example, the first temperature sensor may be disposed adjacent to the susceptor to obtain information regarding an increase or decrease in the temperature of the susceptor. For example, the first temperature sensor may be an NTC temperature sensor.

In operation 610, when receiving the input for heating the susceptor of the aerosol-generating device, the aerosol-generating device may obtain a sensor temperature by using the first temperature sensor disposed within a body of the aerosol-generating device. The sensor temperature may be measured, for example, at a time point the input for heating the susceptor is received.

In operation 620, the aerosol-generating device may determine whether the sensor temperature is a value within a predetermined temperature range. The predetermined temperature range for a second sensor temperature may be, for example, a range from 0° C. to 50° C. For example, when the temperature of the susceptor is outside the predetermined temperature range, the aerosol-generating device may determine that consecutive smoking is being performed or that the frequency of the heating signal may be incorrectly determined.

For example, when the sensor temperature is a value within the preset temperature range, the aerosol-generating device may perform operation 510 in order to perform operations for determining the frequency of the heating signal.

For example, when the sensor temperature is a value outside the preset temperature range, the aerosol-generating device may not perform operations for determining the frequency of the heating signal but may perform the PID power control, as in operation 540.

In operation 630, the aerosol-generating device may apply the first heating signal having the first heating frequency previously determined to the coil of the heater so that the PID power control may be performed. When it is determined that consecutive smoking is being performed or that the frequency of the heating signal may be incorrectly determined, the aerosol-generating device may perform the PID power control by using the first heating frequency that is previously determined.

FIG. 7 is a flowchart of a method of determining an electrical characteristic of a susceptor, according to one embodiment.

Operation 710 below may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operation 520 described above with reference to FIG. 5 may include operation 710.

In operation 710, the aerosol-generating device may determine a first value based on at least one of a current, voltage, or power of a first output signal indicated at an output end of a coil of a heater. For example, the aerosol-generating device may further include a detection circuit for determining the first value of the electrical characteristic of the susceptor indicated by a first signal at the output end of the coil of the heater. The detection circuit may not be electrically connected to the susceptor.

For example, the electrical characteristic may be at least one of the current, the voltage, or the power of the first output signal indicated at the output end of the coil of the heater. For example, the electrical characteristic may be a characteristic determined based on at least one of the current, the voltage, or the power of the first output signal indicated at the output end of the coil of the heater. For example, the electrical characteristic may be an eddy current generated in the susceptor. For example, the electrical characteristic may be an impedance of the susceptor. As an alternating magnetic field generated in the coil of the heater generates an eddy current, some of electric energy of the first signal may be transferred to the susceptor, and current, voltage, or power of the first signal may be different from the current, the voltage, or the power of the first output signal.

FIG. 8 is a flowchart of a method of determining a heating frequency based on a sensor temperature, according to one embodiment.

Operations 810 to 830 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operation 530 described above with reference to FIG. 5 may include operations 810 to 830.

According to one embodiment, the aerosol-generating device may include a first temperature sensor (e.g., the temperature sensor 131 of FIG. 4) disposed adjacent to the susceptor to measure a temperature and may determine a heating frequency based on a sensor temperature sensed by the first temperature sensor. For example, the first temperature sensor may be disposed adjacent to the susceptor to obtain information regarding an increase or decrease in the temperature of the susceptor. For example, the first temperature sensor may be an NTC temperature sensor.

In operation 810, the aerosol-generating device may obtain the sensor temperature by using the first temperature sensor disposed within a body of the aerosol-generating device. The sensor temperature may be measured, for example, at a time point a first signal is applied.

In operation 820, the aerosol-generating device may correct a first value, based on a first sensor temperature, to correspond to an electrical characteristic of the susceptor of a case in which the temperature of the susceptor is a first reference temperature. Since a magnitude of an eddy current generated by the first signal having a first frequency may change corresponding to the temperature of the susceptor, a change in the magnitude of the eddy current due to external factors (e.g., an external temperature and residual heat of the susceptor) may be corrected by correcting the first value by a first sensor temperature.

For example, the electrical characteristic of the susceptor may be the magnitude of the eddy current, and the first reference temperature may be 25° C. As the temperature of the susceptor increases, the eddy current generated corresponding to the first signal having the first frequency may decrease. Based on this, if the magnitude of the eddy current generated by the first signal when the first sensor temperature is 45° C. is 900, the magnitude of the eddy current may be corrected to 950 based on 25° C. If the magnitude of the eddy current generated by the first signal when the first sensor temperature is 35° C. is 930, the magnitude of the eddy current may be corrected to 950 based on 25° C. If the magnitude of the eddy current generated by the first signal when the first sensor temperature is 0° C. is 1000, the magnitude of the eddy current measured may be corrected to 950 based on 25° C. The above-mentioned values of the magnitude of the eddy current are arbitrary values mentioned to illustrate changes in the values, and embodiments are not limited thereto.

In operation 830, the aerosol-generating device may determine a first heating frequency so that a second value of the electrical characteristic of the susceptor that is indicated by a second signal having the first heating frequency may correspond to a first reference value. The first reference value may be based on, for example, the electrical characteristic of the susceptor of a case in which the temperature of the susceptor is the first reference temperature.

For example, the electrical characteristic of the susceptor may be an eddy current, and the magnitude of an eddy current generated by a signal at a frequency adjacent to the first frequency may increase as the frequency decreases and may decrease as the frequency increases. For example, when the first value is smaller than the first reference value, a frequency lower than the first frequency may be determined as the first heating frequency so that a magnitude of an eddy current generated by the second signal may be closer to the first reference value. For example, when the first value is larger than the first reference value, a frequency higher than the first frequency may be determined as the first heating frequency so that the magnitude of the eddy current generated by the second signal may be closer to the first reference value.

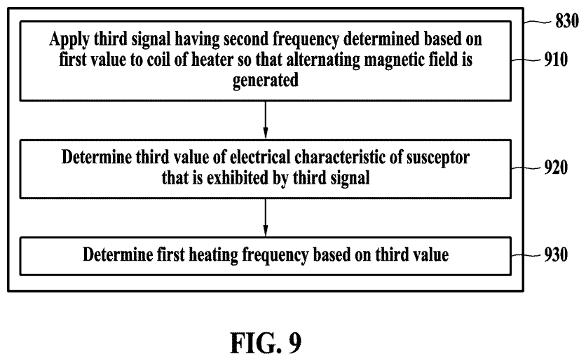

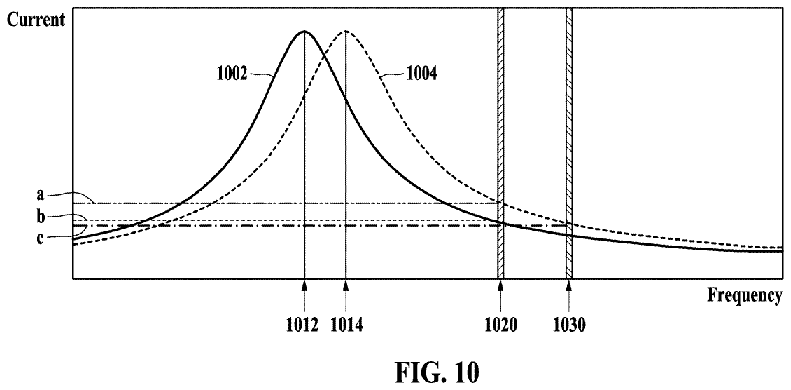

According to one embodiment, the aerosol-generating device may compare the electrical characteristic of the susceptor generated by a signal of a particular frequency to a reference value to determine a new frequency, and may compare again the electrical characteristic of the susceptor indicated by a signal of the new frequency to the reference value to determine a frequency of a signal that may induce the electrical characteristic of the susceptor corresponding to the reference value. The operation of determining the heating frequency so that the electrical characteristic of the susceptor may correspond to the reference value is described in detail below with reference to FIGS. 9 and 10.

FIG. 9 is a flowchart of a method of determining a heating frequency so that an electrical characteristic of a susceptor corresponds to a reference value, according to one embodiment, and FIG. 10 shows trajectories of eddy currents in a susceptor generated by a frequency of a signal, according to one embodiment.

Operations 910 to 930 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operation 830 described above with reference to FIG. 8 may include operations 910 to 930.

According to one embodiment, the aerosol-generating device may compare the electrical characteristic of the susceptor indicated by a signal of a particular frequency to a reference value to determine a new frequency, and may compare again the electrical characteristic of the susceptor indicated by a signal of the new frequency to the reference value to determine a frequency of a signal that may induce the electrical characteristic of the susceptor corresponding to the reference value.

In operation 910, the aerosol-generating device may apply a third signal having a second frequency 1030 determined based on a first value a to a coil of a heater so that an alternating magnetic field may be generated. The description of operation 510 provided above with reference to FIG. 5 may similarly apply to operation 910.

For example, the electrical characteristic of the susceptor may be an eddy current, and the magnitude of an eddy current in the susceptor generated by a signal at a frequency adjacent to a first frequency 1020 may increase as the frequency decreases and may decrease as the frequency increases. For example, when the first value a is smaller than a first reference value b, the second frequency 1030 may be determined to be lower than the first frequency 1020 so that a magnitude of an eddy current generated by the third signal may be closer to the first reference value b. For example, when the first value a is larger than the first reference value b, the second frequency 1030 may be determined to be higher than the first frequency 1020 so that the magnitude of the eddy current generated by the third signal may be closer to the first reference value b.

In operation 920, the aerosol-generating device may determine a third value c of the electrical characteristic of the susceptor indicated by the third signal. The description of operation 520 provided above with reference to FIGS. 5 and 7 may similarly apply to operation 920.

In operation 930, the aerosol-generating device may determine a first heating frequency based on the third value c. The aerosol-generating device may determine the first heating frequency so that a second value of the electrical characteristic of the susceptor that is indicated by a second signal having the first heating frequency may correspond to the first reference value b.

For example, when the third value c is smaller than the first reference value b, a frequency lower than the second frequency 1030 may be determined as the first heating frequency so that a magnitude of an eddy current generated by the second signal may be close to the first reference value b. For example, when the third value c is larger than the first reference value b, a frequency higher than the second frequency 1030 may be determined as the first heating frequency so that the magnitude of the eddy current generated by the second signal may be closer to the first reference value b.

Referring to FIG. 10, as a first natural frequency 1012 of a reference susceptor is different from a second natural frequency 1014 of the susceptor (e.g., the heater 18 of FIG. 1, the heater 182 of FIGS. 2 and 4, or the heater 183 of FIG. 3) disposed in the aerosol-generating device, a first eddy current trajectory 1002 of the reference susceptor may be different from a second eddy current trajectory 1004 of the susceptor disposed in the aerosol-generating device. If the aerosol-generating device (e.g., the aerosol-generating device 1 of FIGS. 1 to 4) is capable of performing a frequency sweep over the entire frequency band, the aerosol-generating device may generate the first natural frequency 1012 of the reference susceptor and the second natural frequency 1014 of the susceptor disposed in the aerosol-generating device.

According to one embodiment, the aerosol-generating device may determine the first heating frequency so that the magnitude of an eddy current in the susceptor generated by a signal of the first heating frequency may be identical to the magnitude of an eddy current generated in the reference susceptor by a signal of the first frequency 1020.

According to one embodiment, the reference susceptor and the susceptor disposed in the aerosol-generating device may indicate different electrical characteristics for the same signal. For example, when a first signal having the first frequency 1020 is applied, the reference susceptor may generate an eddy current of the reference value b, whereas the susceptor disposed in the aerosol-generating device may generate an eddy current of the first value a.

For example, as illustrated in FIG. 10, the magnitude of an eddy current in the susceptor generated by a signal at a frequency adjacent to the first frequency 1020 may increase as the frequency decreases and may decrease as the frequency increases. Since the first value a is larger than the first reference value b as illustrated, the second frequency 1030 may be determined to be higher than the first frequency 1020. Since the third value c is smaller than the first reference value b as illustrated, a frequency lower than the second frequency 1030 may be determined as the first heating frequency.

According to one embodiment, the magnitude of the eddy current in the susceptor generated by the signal frequency may be indirectly obtained from a detection circuit connected to an output end of the coil of the heater. Since the eddy current may be generated as at least some of electric energy of the signal applied to the coil of the heater is absorbed by the susceptor, the detection circuit may indirectly obtain the magnitude of the eddy current in the susceptor by comparing current, voltage, or power of the signal applied to the coil of the heater to current, voltage, or power of an output signal. When the eddy current in the susceptor is indirectly obtained through the detection circuit, the susceptor of the aerosol-generating device may be easily replaced as the susceptor is not electrically connected to other components of the aerosol-generating device.

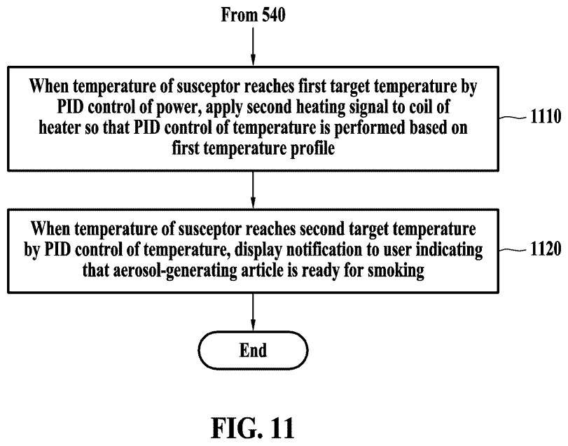

FIG. 11 is a flowchart of a method of preheating a susceptor, according to one embodiment.

Operations 1110 and 1120 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operations 1110 and 1120 may be performed after operation 540 described above with reference to FIG. 5 is performed.

According to one embodiment, the aerosol-generating device may operate in a preheat mode to preheat the susceptor to a target temperature, and the preheat mode may include a plurality of sections. For example, the aerosol-generating device may heat the susceptor to a first target temperature by performing PID power control in a first section of the preheat mode. For example, the aerosol-generating device may heat the susceptor to a second target temperature by performing PID temperature control in a second section of the preheat mode. The aerosol-generating device may perform the PID power control so that the susceptor may be quickly and efficiently heated in the first section and may perform the PID temperature control so that a temperature of the susceptor may be correctly controlled in the second section.

In operation 1110, when the temperature of the susceptor reaches the first target temperature by the PID power control, the aerosol-generating device may apply a second heating signal to a coil of a heater so that the PID temperature control may be performed based on a first temperature profile. For example, a frequency of the second heating signal may be a first frequency. For example, a frequency of the second heating signal may be a first heating frequency. The temperature of the susceptor may be correctly controlled as the PID temperature control is performed.

In operation 1120, when the temperature of the susceptor reaches a second target temperature by the PID temperature control, the aerosol-generating device may display a notification to a user indicating that an aerosol-generating article is ready for smoking. When a preheating of the susceptor and the aerosol-generating article is completed as the temperature of the susceptor reaches the second target temperature, the user's smoking may be performed. For example, the aerosol-generating device may apply a third heating signal to the coil of the heater so that the PID temperature control may be performed based on a second temperature profile corresponding to the user's smoking.

Some embodiments of the disclosure described above or other embodiments are not mutually exclusive or distinct from each other. Some embodiments of the disclosure described above or other embodiments may be used jointly or combined with each other in configuration or function.

For example, a configuration A described in an embodiment and/or drawing and a configuration B described in another embodiment and/or drawing may be combined with each other. That is, although the combination of the configurations is not directly described, the combination is possible except when it is described that the combination is impossible.

The detailed description above should not be construed as limiting in any aspect but should be considered illustrative. The scope of the present disclosure should be determined by rational interpretation of the appended claims, and all variations within the scope of equivalents of the present disclosure are included in the scope of the present disclosure.

What is claimed is:

1. A method of controlling a heater of an aerosol-generating device, the method comprising:
applying a first signal having a first frequency to a coil of the heater so that an alternating magnetic field is generated;
determining a first value of an electrical characteristic of a susceptor indicated by the first signal;
determining a first heating frequency based on the first value; and
applying a first heating signal having the first heating frequency to the coil of the heater so that proportional-integral-differential (PID) power control is performed based on a first power profile.

2. The method of claim 1, wherein the determining of the first heating frequency based on the first value comprises:
determining the first heating frequency so that a second value of the electrical characteristic of the susceptor indicated by a second signal having the first heating frequency corresponds to a first reference value.

3. The method of claim 2,
wherein the first reference value is based on the electrical characteristic of the susceptor of a case in which a temperature of the susceptor is a first reference temperature, and
wherein the determining of the first heating frequency based on the first value further comprises:
obtaining a first sensor temperature by using a first temperature sensor disposed within a body of the aerosol-generating device; and
correcting the first value, based on the first sensor temperature, to correspond to the electrical characteristic of the susceptor of the case in which the temperature of the susceptor is the first reference temperature.

4. The method of claim 1, wherein the determining of the first heating frequency based on the first value comprises:
applying a third signal having a second frequency determined based on the first value to the coil of the heater so that an alternating magnetic field is generated;
determining a third value of the electrical characteristic of the susceptor indicated by the third signal; and
determining the first heating frequency based on the third value.

5. The method of claim 1, wherein the determining of the first value of the electrical characteristic of the susceptor comprises:
determining the first value based on at least one of a current, voltage, or power of a first output signal indicated at an output end of the coil of the heater.

6. The method of claim 5, wherein the electrical characteristic of the susceptor is an eddy current.

7. The method of claim 1, further comprising:
when a temperature of the susceptor reaches a first target temperature by the PID power control, applying a second heating signal to the coil of the heater so that PID temperature control is performed based on a first temperature profile.

8. The method of claim 7, further comprising:
when the temperature of the susceptor reaches a second target temperature by the PID temperature control, displaying a notification to a user indicating that an aerosol-generating article is ready for smoking.

9. The method of claim 7, wherein a frequency of the second heating signal is the first frequency.

10. The method of claim 7, wherein a frequency of the second heating signal is the first heating frequency.

11. The method of claim 1, wherein, when an input for heating the susceptor of the aerosol-generating device is received, the first signal having the first frequency is applied to the coil of the heater.

12. The method of claim 1, further comprising:
when an input for heating the susceptor of the aerosol-generating device is received, obtaining a second sensor temperature by using a first temperature sensor disposed within a body of the aerosol-generating device,
wherein, when the second sensor temperature is a value within a predetermined temperature range, the first signal having the first frequency is applied to the coil of the heater, and
wherein, when the second sensor temperature is a value outside the predetermined temperature range, the first heating signal having the first heating frequency previously determined is applied to the coil of the heater so that the PID power control is performed.

13. A non-transitory computer-readable storage medium storing instructions that, when executed by a processor, cause the processor to perform the method of claim 1.

14. An aerosol-generating device comprising:
an induction coil configured to generate an alternating magnetic field; and
a controller configured to control the aerosol-generating device,
wherein the controller is further configured to:
apply a first signal having a first frequency to a coil to a heater so that an alternating magnetic field is generated;
determine a first value of an electrical characteristic of a susceptor indicated by the first signal;
determine a first heating frequency based on the first value; and
apply a first heating signal having the first heating frequency to the coil of the heater so that proportional-integral-differential (PID) power control is performed based on a first power profile.

15. The aerosol-generating device of claim 14, further comprising:
a first temperature sensor disposed within a body of the aerosol-generating device,
wherein, regarding the determining of the first heating frequency, the controller is configured to:
obtain a first sensor temperature by using the first temperature sensor;
correct the first value, based on the first sensor temperature, to correspond to the electrical characteristic of the susceptor of a case in which a temperature of the susceptor is a first reference temperature; and
determine the first heating frequency so that a second value of the electrical characteristic of the susceptor indicated by a second signal having the first heating frequency corresponds to a first reference value.
